(19) United States
(12) Patent Application Publication
(10) Pub. No.: US 2026/0260062 A1
(43) Pub. Date: Sep. 3, 2026

(54) Conference Record Processing Method, Apparatus, Device, and Storage Medium

(71) Applicant: ALIBABA INNOVATION PRIVATE LIMITED, Singapore (SG)

(72) Inventors: Jiaqing LIU, Beijing (CN); Chong DENG, Hangzhou, Zhejiang (CN)

(21) Appl. No.: 18/863,616

(22) PCT Filed: Jun. 19, 2023
(86) PCT No.: PCT/CN2023/101178

§ 371 Date: Nov. 6, 2024

(30) Foreign Application Priority Data
Jun. 20, 2022 (CN) 202210698112.3

(51) Int. Cl. G06F 40/279; G06F 40/166; G06N 3/047

(52) U.S. Cl. CPC G06F 40/279; G06F 40/166; G06N 3/047

(57) ABSTRACT

The present disclosure relates to a conference record processing method, an apparatus, a device, and a storage medium. The method includes that: a target sentence to be processed in a conference record is obtained; the target sentence is at least encoded by using a trained machine learning model to obtain a representation vector of the target sentence; a probability value containing an action item in the target sentence is determined according to the representation vector of the target sentence; and in response to determining, based on the probability value, that the target sentence contains the action item, related elements of the action item are obtained, the related elements being used for assisting a user in following up on to-do items and organizing a conference summary.

The present disclosure claims priority of Chinese Patent Application No. 202210698112.3, filed to China Patent Office on Jun. 20, 2022 and titled “Conference Record Processing Method, Apparatus, Device, and Storage Medium”, the content of which is hereby incorporated by reference in its entirety.

### TECHNICAL FIELD

The present disclosure relates to the field of information technology, and in particular, to a conference record processing method, an apparatus, a device, and a storage medium.

### BACKGROUND OF THE INVENTION

With the continuous development of technology, under the support of Automatic Speech Recognition (ASR) technology, speech in a conference is automatically recognized as text, so as to obtain a conference record. On the basis of the conference record, a conference summary is further sorted out. For example, issues, conclusions, questions, tasks and other information are sorted from the conference record to generate the conference summary.

However, inventors of the present disclosure finds that a sorting process from the conference record to the conference summary is usually manually sorted, thereby wasting time and labor.

### SUMMARY OF THE INVENTION

At least some embodiments of the present disclosure provide a conference record processing method, an apparatus, a device, and a storage medium, so as at least to solve the above technical problem, thereby improving the conversion efficiency from a conference record to a conference summary.

According to a first aspect, some embodiments of the present disclosure provide a conference record processing method, including that:
a target sentence to be processed in a conference record is obtained;
the target sentence is at least encoded by using a trained machine learning model to obtain a representation vector of the target sentence;
a probability value containing an action item in the target sentence is determined according to the representation vector of the target sentence; and
in response to determining, based on the probability value, that the target sentence contains the action item, related elements of the action item are obtained, the related elements being used for assisting a user in following up on to-do items and organizing a conference summary.

According to a second aspect, some embodiments of the present disclosure provide a conference record processing apparatus, including:
a first obtaining module, arranged for obtaining a target sentence to be processed in a conference record;
an encoding module, arranged for at least encoding the target sentence by using a trained machine learning model to obtain a representation vector of the target sentence;
a determining module, arranged for determining a probability value containing an action item in the target sentence according to the representation vector of the target sentence; and
a second obtaining module, arranged for in response to determining, based on the probability value, that the target sentence contains the action item, obtaining related elements of the action item, the related elements being used for assisting a user in following up on to-do items and organizing a conference summary.

According to a third aspect, some embodiments of the present disclosure provide an electronic device, including:
a memory;
a processor; and
a computer program;
where the computer program is stored in the memory and arranged for being executed by the processor to implement the method according to the first aspect.

According to a fourth aspect, some embodiments of the present disclosure provide a computer-readable storage medium, storing a computer program, where the computer program, when being executed by a processor, implements the method according to the first aspect.

According to the conference record processing method, the apparatus, the device, and the storage medium provided in the embodiments of the present disclosure, the target sentence to be processed in the conference record is obtained; the target sentence is at least encoded by using the trained machine learning model to obtain the representation vector of the target sentence; the probability value containing the action item in the target sentence is determined according to the representation vector of the target sentence; and in response to determining, based on the probability value, that the target sentence contains the action item, related elements of the action item are obtained, the related elements being used for assisting the user in following up on to-do items and organizing the conference summary. In other words, the machine learning model can automatically recognize the target sentence containing the action item in the conference record, and the electronic device deployed with the machine learning model or other electronic devices can automatically obtain the related elements of the action item, thereby assisting the user in following up on to-do items and organizing a conference summary. In addition, a process of manual organization from the conference record to the conference summary is omitted, thereby improving the conversion efficiency from the conference record to the conference summary.

### BRIEF DESCRIPTION OF DRAWINGS

The accompanying drawings, which are incorporated in the specification, constitute a part of the specification, illustrate embodiments consistent with the present disclosure and, together with the specification, serve to explain principles of the present disclosure.

In order to more clearly illustrate the embodiments of the present disclosure or the technical solutions in the related art, the drawings required in the embodiments or the related art will be briefly described below, and it is obvious to those skilled person in the art that other drawings can be obtained according to these drawings without creative efforts.

FIG. 1 is a flowchart of a conference record processing method according to some embodiments of the present disclosure.

FIG. 2 is a schematic diagram of an application scenario according to some embodiments of the present disclosure.

FIG. 3 is a schematic diagram of a training process of a machine learning model according to some embodiments of the present disclosure.

FIG. 4 is a flowchart of another conference record processing method according to some embodiments of the present disclosure.

FIG. 5 is a flowchart of another conference record processing method according to some embodiments of the present disclosure.

FIG. 6 is a flowchart of another conference record processing method according to some embodiments of the present disclosure.

FIG. 7 is a flowchart of another conference record processing method according to some embodiments of the present disclosure.

FIG. 8 is a flowchart of another conference record processing method according to some embodiments of the present disclosure.

FIG. 9 is a flowchart of another conference record processing method according to some embodiments of the present disclosure.

FIG. 10 is a structural schematic diagram of a conference record processing apparatus according to some embodiments of the present disclosure.

FIG. 11 is a structural schematic diagram of an electronic device according to some embodiments of the present disclosure.

### DETAILED DESCRIPTION OF THE INVENTION

In order to understand the above objects, features and advantages of the present disclosure more clearly, the solutions of the present disclosure will be further described below. It should be noted that, in the case of no conflict, the embodiments of the present disclosure and the features in the embodiments may be combined with each other.

Many specific details are set forth in the following description in order to fully understand the present disclosure, but the present disclosure may also be implemented in other manners different from those described herein. Obviously, the embodiments in the specification are a part but not all of the embodiments of the present disclosure.

Generally, under the support of Automatic Speech Recognition (ASR) technology, speech in a conference is automatically recognized as text, so as to obtain a conference record. On the basis of the conference record, a conference summary is further sorted out. For example, issues, conclusions, questions, tasks and other information are sorted from the conference record to generate the conference summary. However, inventors of the present disclosure finds that a sorting process from the conference record to the conference summary is usually manually sorted, thereby wasting time and labor. For this problem, some embodiments of the present disclosure provide a conference record processing method, which is described below with reference to specific embodiments.

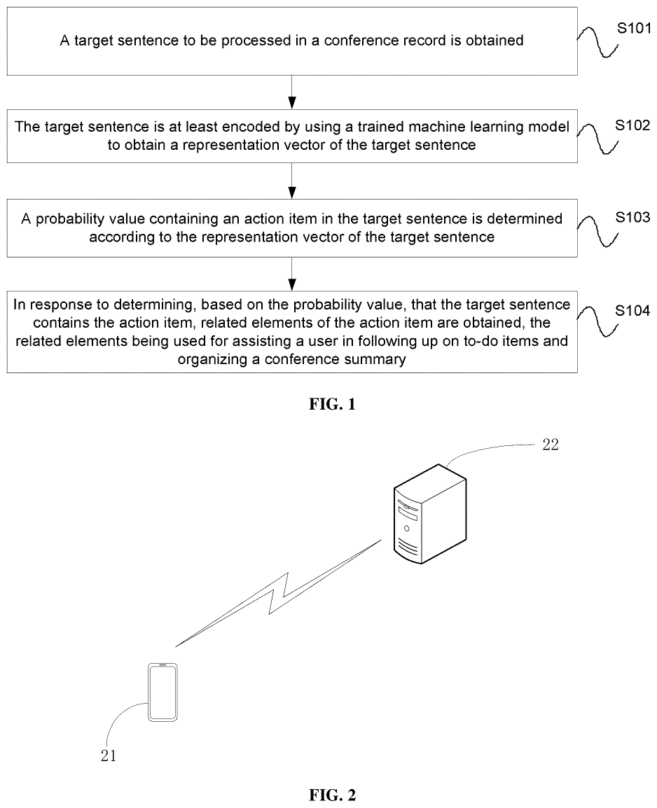

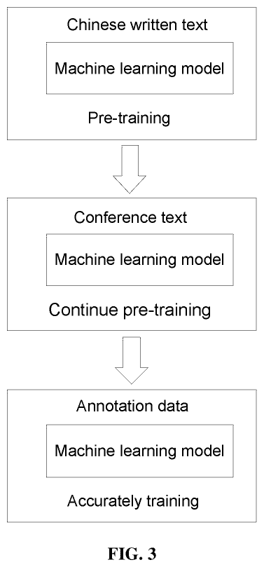

FIG. 1 is a flowchart of a conference record processing method according to some embodiments of the present disclosure. The method is performed by a conference record processing apparatus, the apparatus is implemented by using software and/or hardware, and the apparatus is arranged in an electronic device, for example, a server or a terminal, where the terminal specifically includes a mobile phone, a computer, a tablet computer, or the like. In addition, the conference record processing method provided in some embodiments of the present disclosure is applied to the application scenario including a terminal 21 and a server 22 shown in FIG. 2. The terminal 21 is a terminal used by a user when this user participates in an online conference, or the terminal 21 is a terminal carried by the user when the user participates in the offline conference, or the terminal 21 is a terminal in an offline conference room. Specifically, the terminal 21 collects a conference audio, and convert the conference audio into a conference record by using an ASR technology. Further, the terminal 21 sends the conference record to the server 22. The server 22 implements the method described in some embodiments to recognize a sentence containing the action item from the conference record, where the sentence containing the action item is used for assisting the user in following up on to-do items and organizing a conference summary. Alternatively, the terminal 21 implements the method described in some embodiments to recognize the sentence containing the action item from the conference record. For a conference, the conference summary is an important text summary and precipitation product, and has an important impact on the improvement of the execution efficiency after the conference. In addition, a process of converting the conference audio into the conference record by using the ASR technology is not limited to being executed on the terminal 21. For example, the terminal 21 further sends the conference audio collected by the terminal 21 to the server 22, so that the server 22 converts the conference audio into the conference record by using the ASR technology. A process of the server 22 implementing the method in some embodiments is taken as an example for schematic description. As shown in FIG. 1, the method includes the following steps.

In step S101, a target sentence to be processed in a conference record is obtained.

For example, the terminal 21 sends the conference record to the server 22, and the server 22 obtains the target sentence to be processed from the conference record. The target sentence is any sentence in the conference record. Alternatively, the target sentence is a sentence meeting a certain condition in the conference record.

In step S102, the target sentence is at least encoded by using a trained machine learning model to obtain a representation vector of the target sentence.

For example, the trained machine learning model is deployed on the server 22, which includes a trained converter-based bidirectional encoder representation (BERT) model or other model which has been trained. Specifically, the server 22 at least encodes the target sentence by using the BERT model to obtain the representation vector of the target sentence.

In step S103, a probability value containing an action item in the target sentence is determined according to the representation vector of the target sentence.

For example, the machine learning model further includes a fully connected layer. When the server 22 obtains the representation vector of the target sentence, the server 22 inputs the representation vector of the target sentence into the fully connected layer to output two probability values. One probability value is a probability value containing the action item in the target sentence, and the other probability value is a probability value that does not contain the action item in the target sentence, and the sum of the two probability values is 1.

In step S104, in response to determining, based on the probability value, that the target sentence contains the action item, related elements of the action item are obtained, the related elements being used for assisting a user in following up on to-do items and organizing a conference summary.

Specifically, the server 22 determines, based on the probability value of the action item contained in the target sentence, whether the target sentence contains the action item. For example, if the probability value of the action item contained in the target sentence is greater than the probability value that does not contain the action item in the target sentence, or the probability value of the action item contained in the target sentence is greater than a certain threshold, it is determined that the target sentence contains the action item. When the server 22 determines that the target sentence contains the action item, the related elements of the action item are further obtained. The related elements include personal information, time information, content information and the like corresponding to the action item. The related elements are arranged for assisting a user in following up on to-do items and organizing a conference summary. It is understood that the conference summary not only includes the related elements of the action item, but also includes information such as a conference issue, a conference conclusion, and a question discussed in the conference. The action item refers to a specific action item performed by a conference-related party after a conference. The action item of the conference is required to be sorted in the conference summary, for example, recording in a to-do item such as a next action, a subsequent action, a subsequent pending and the like, or into a pending list of the corresponding responsible person. The action item is set as the pending item after the conference to follow and feedback. The action item is, for example, “I will go back and tally up the numbers tonight”, “Next, we need to produce a report”, and so on. For a working conference, the action item is necessary and important, thus some embodiments select the identification of the action item as an entry point. In one aspect, the action item is necessary content of a working conference summary. The work conference often involves contents such as information sharing, problem resolution, plan formulation, task arrangement, etc. and the action item is implied in the contents, such as the implementation of suggestions and solutions, the execution of planning and task actions, and the like. On the other hand, the action item is a key content which improves the efficiency of execution after the conference. After the action item is recognized, the process of creating, arranging, notifying, synchronizing and checking the action item can be streamlined. Through follow-up of subsequent actions, the conference summary is not just a text record of the conference, but also used for assisting in perfecting a post-conference management platform, so as to greatly promote the improvement of the execution efficiency after the conference. Therefore, the action item is selected as the entry point, so that the conference summary can be assisted, and the post-meeting execution efficiency can be improved. In addition, a recognition process of other contents in the conference summary can refer to the recognition process of the action item, and details are not described herein again.

Through the embodiments of the present disclosure, the target sentence to be processed in the conference record is obtained and the target sentence is at least encoded by using the trained machine learning model to obtain the representation vector of the target sentence. Furthermore, the probability value containing the action item in the target sentence is determined according to the representation vector of the target sentence. In response to determining, based on the probability value, that the target sentence contains the action item, the related elements of the action item are obtained, the related elements being used for assisting the user in following up on to-do items and organizing the conference summary. In other words, the machine learning model can automatically recognize the target sentence containing the action item in the conference record, and the electronic device deployed with the machine learning model or other electronic devices can automatically obtain the related elements of the action item, thereby assisting the user in following up on to-do items and organizing the conference summary. In addition, a process of manual organization from the conference record to the conference summary is omitted, thereby improving the conversion efficiency from the conference record to the conference summary.

On the basis of the foregoing embodiments, an operation of determining the probability value containing the action item in the target sentence according to the representation vector of the target sentence includes the following steps. The probability value containing the action item in the target sentence is determined according to the representation vector of the target sentence and position information of the target sentence in the conference record.

For example, when the server 22 obtains the representation vector of the target sentence, the server 22 inputs the representation vector of the target sentence and the position information of the target sentence in the conference record to the fully connected layer to output two probability values. One probability value is a probability value containing the action item in the target sentence, and the other probability value is a probability value that does not contain the action item in the target sentence, and the sum of the two probability values is 1.

In some embodiments, the probability value containing the action item in the target sentence is determined according to the representation vector of the target sentence and the position information of the target sentence in the conference record. Since there are more types of information input into the fully connected layer, for example, the representation vector of the target sentence and the position information of the target sentence in the conference record, the fully connected layer can more accurately calculate the probability value containing the action item in the target sentence.

It can be understood that, in the foregoing embodiments, the process of determining whether the target sentence contains the action item by using the machine learning model is a use stage or an inference stage of the machine learning model. In the use phase or the inference phase, the machine learning model can determine whether each sentence in the conference record contains the action item. In some embodiments of the present disclosure, the recognition of the action item is regarded as a two-classification task. For example, an input of the machine learning model is one sentence in the conference record, and an output of the machine learning model is a determination result of whether the sentence contains the action item. In addition, in some other embodiments, the recognition of the action item can also be regarded as a multi-classification task, and the related elements of the action item include personal information (for example, a responsible person), time information (for example, a time limit), content information (for example, an action description), whether to confirm an action, and the like.

In addition, before the use phase or the inference phase of the machine learning model, the machine learning model is required to be trained. In some embodiments of the present disclosure, the machine learning model is obtained through three training stages. A first training stage is a pre-training process, sample data used in this pre-training process is a Chinese written text, and may not be data such as the conference record or a conference text. A second training stage is also the pre-training process, and the sample data used in this pre-training process is data such as the conference record or the conference text. That is, after the machine learning model is pre-trained in the first training stage, the machine learning model is continuously pre-trained by using data such as the conference record or the conference text. In the pre-training process, the sample data may be unlabeled data. For example, in the pre-training process, some words in the sample data may be masked, so that the machine learning model predicts the masked words, and the machine learning model is trained according to the masked words predicted by the machine learning model and the words which are actually masked. It can be understood that the pre-training process is not limited to this training method, and there may be other training methods, and details are not described herein again.

After the machine learning model is pre-trained in the second training stage, the machine learning model is accurately trained through a third training stage. Sample data in the third training stage is annotation data, for example, a sentence containing the action item and a sentence that does not contain the action item. The sentence containing the action item is marked as a positive example, and the sentence that does not contain the action item is marked as a negative example. In addition, a ratio between the number of the positive example and the number of the negative example is not limited. In a data labeling process, in order to protect the security and privacy of data, the order of all sentences in at least one conference record is scrambled, sensitive information such as a name and an institution name in each sentence after the shuffling sequence is removed, then each sentence is labeled, and a labeling result is used for indicating whether the sentence contains the action item. In addition, since most of the positive examples include time words and action words, in a data labeling process, sentences containing the time words and the action words can be reserved for manual labeling, the manual labeling has both positive example labeling and negative example labeling, so that useless labeling can be reduced, and the labeling cost is reduced. In addition, in a data annotation process, it can be determined whether a sentence relates to a specific action item after the conference. When the sentence relates to the specific action item after the conference, the sentence marked as a positive example is pending data, and when the sentence does not relate to the specific action item after the conference, the sentence marked as a negative example is non-pending data. In addition, considering the problem that the subjectivity may be relatively strong in the labeling process, in some embodiments, a probable pending category is set, thereby reflecting some ambiguous states. Furthermore, in some embodiments, the number of sentences in the positive example or the negative example is expanded through multiple data enhancement manners. For example, for the labeled positive example or negative example, the number of sentences in the positive example or the negative example is expanded by synonym replacement, randomly replacing positions of the two words, randomly deleting one word, randomly inserting one word. In addition, the number of sentences in the positive example or the negative example is expanded based on text generation, interpretation, and the like of the pre-trained language model. A method for expanding the number of sentences through a pre-trained mask language model (MLM) is adopted to mask one word in one positive example or one negative example, so that the MLM can predict the masked word. It is assumed that the MLM predicts five words, and then these five words are respectively put back to the position of the word which is actually masked, so as to obtain five new sentences. An interpretation manner is adopted to translate a Chinese sentence into other foreign languages, such as an English sentence, based on the trained machine translation model, and then the interpretation manner is further adopted to translate the English sentence into another Chinese sentence. In this case, the translated Chinese sentence may change compared with the original Chinese sentence, and the translated Chinese sentence obtained after the second translation may be used as an expanded sentence.

Specifically, in the third training stage, the sample data may be an annotated sentence. At this time, the sample data may be input into the machine learning model to output the probability value containing the action item and the probability value that does not contain the action item in the sample data. Further, a loss function is calculated according to the sample data being the positive example or the negative example and two probability values output by the machine learning model, and parameters of the machine learning model are updated according to the loss function.

Alternatively, in the third training stage, the sample data may be a conference record, and the order of each sentence in the conference record is a normal sequence, that is, the order of each sentence in the conference record is not scrambled. Each sentence in the conference record has been labeled as the positive example or the negative example. Furthermore, one sentence is randomly selected from the conference record as a current sentence, and a previous sentence and a next sentence of the current sentence are obtained. The previous sentence, the current sentence, and the next sentence are taken together as the input of the machine learning model, and related information of the context of the current sentence can be provided through the previous sentence and the next sentence. The machine learning model outputs the probability value containing the action item and the probability value that does not contain the action item in the current sentence, and further calculates a loss function according to the current sentence being the positive example or the negative example and two probability values output by the machine learning model. Parameters of the machine learning model are updated according to the loss function. In the aspect of the loss function, some embodiments can alleviate the problem of sample imbalance by the focal loss, and reduce the influence of labeling errors by label smoothing. In addition, different sentence-level encoding representations, thresholds, and hyper-parameters are further used in some embodiments to obtain an optimal model representation. In addition, a fixed-length input is updated to a variable-length input, which can improve the operation speed of the machine learning model. Specifically, the three training stages as described above are shown in FIG. 3.

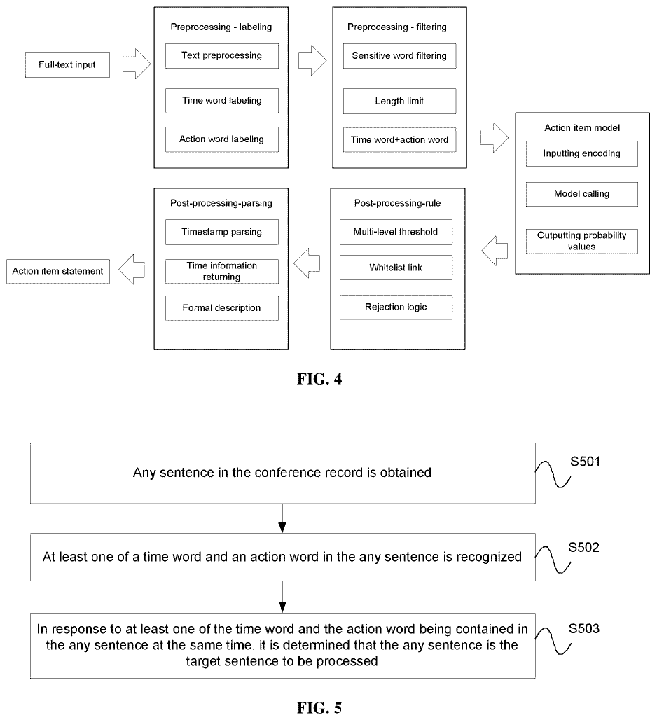

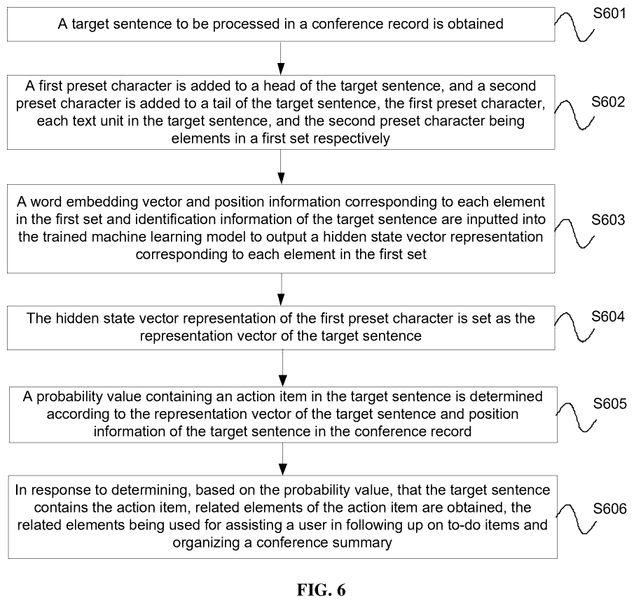

The machine learning model obtained after the three training stages as described above may be an action item model as shown in FIG. 4. That is, the machine learning model obtained after three training stages as described above is used for recognizing a sentence containing an action item in a conference record. The full text in the full text input shown in FIG. 4 is the conference record containing multiple sentences. For each sentence, it may be pre-processed as shown in FIG. 4, which includes marking and filtering. After pre-processing, some sentences in the conference record may be filtered out, some sentences may be left, and remaining sentences may be input into the action item model. The pre-processing process is described below with reference to FIG. 5.

On the basis of the foregoing embodiments, an operation of obtaining the target sentence to be processed in the conference record includes the following steps shown in FIG. 5.

In step S501, any sentence in the conference record is obtained.

For example, the server 22 randomly selects one sentence, that is, any sentence, from the conference record. First, text pre-processing is performed on any sentence, for example, capital letters in any sentence are changed into lower case letters, blank characters are removed from the sentence, and the like.

In step S502, at least one of a time word and an action word in the any sentence is recognized. After the text pre-processing is performed on the any sentence, at least one of a time word and an action word in the any sentence may be recognized. The process of recognizing the time word may be the time word marking as shown in FIG. 4, and the process of recognizing the action word may be the action word marking as shown in FIG. 4. Time word marking refers to recognizing a time word in any sentence and recording related information. For example, some embodiments provide a dictionary of time words and a set of regular expression patterns. Based on the dictionary and the set, a labeler may recognize the time word in the any sentence, and record information such as content, location, and label of the time word. The any sentence may include at least one time word, or may not include any time word. The label of the time word may be used for representing a tense, for example, a label of a certain time word is used for indicating that the time word is a time word representing future, a time word representing present, a time word representing past, or a time word representing pending. Action word marking refers to recognizing an action word in any sentence, and recording related information. In some embodiments, a tokenizer is called to segment the any sentence to obtain the part-of-speech of each word. A word, of which the part-of-speech is a verb, is regarded as the action word, and the part-of-speech is set as a label of the word. At the same time, information such as content, location, and label of the action word will also be recorded.

Optionally, an operation of recognizing at least one of the time word and the action word in the any sentence includes the following step. In response to the any sentence not containing any sensitive word and/or a length of the any sentence meeting a preset condition, at least one of the time word and the action word in the any sentence is recognized.

For example, in some embodiments, after the text pre-processing is performed on any sentence, sensitive word filtering and length limitation may be performed on the any sentence. The sensitive word filtering means that when the any sentence includes a sensitive word, the any sentence is discarded, and when the any sentence does not contain the sensitive word, the any sentence is reserved. The length limit refers to discarding the any sentence when the length of the any sentence is less than the minimum length limit or greater than the maximum length limit, and reserving the any sentence when the length of the any sentence is greater than the minimum length limit and less than the maximum length limit. The minimum length limit and the maximum length limit are both preset. When the any sentence does not contain any sensitive word and/or the length of the any sentence meets a preset condition (for example, between the minimum length limit and the maximum length limit), the time word marking and the action word marking are further performed on the any sentence.

In step S503, in response to at least one of the time word and the action word being contained in the any sentence at the same time, it is determined that the any sentence is the target sentence to be processed.

After the time word marking and the action word marking, the “time word +action word” filtering is performed on the any sentence. That is, it is determined whether the any sentence includes both the time word and the action word. When the time word and the action word are included at the same time, the any sentence may be input into the action item model, otherwise, the sentence may be discarded. Since the action item is required to execute a specific action at a certain time point after the conference, the filtering of the “time word+action word” is regarded as a necessary filtering condition. In addition, when the time word in the any sentence are the time word representing past, it is also considered that there is no time word in the any sentence and the any sentence is discarded. In some embodiments, the sentence remaining after filtering as shown in FIG. 4 is recorded as the target sentence to be processed.

In some embodiments, the time word and/or action word in the any sentence in the conference record are recognized, and the any sentence is filtered by using multiple filtering conditions, so that sentences meeting the filtering condition in the conference record are input into the machine learning model. Therefore, some sentences which do not contain the action items can be filtered out, some sentences which do not obviously contain the action items are avoided to input into the machine learning model to increase the load of the model, the model performance is improved, the calling amount of the model is reduced, and the system performance is improved.

FIG. 6 is a flowchart of another conference record processing method according to some embodiments of the present disclosure. In some embodiments, the method includes the following steps.

In step S601, a target sentence to be processed in a conference record is obtained.

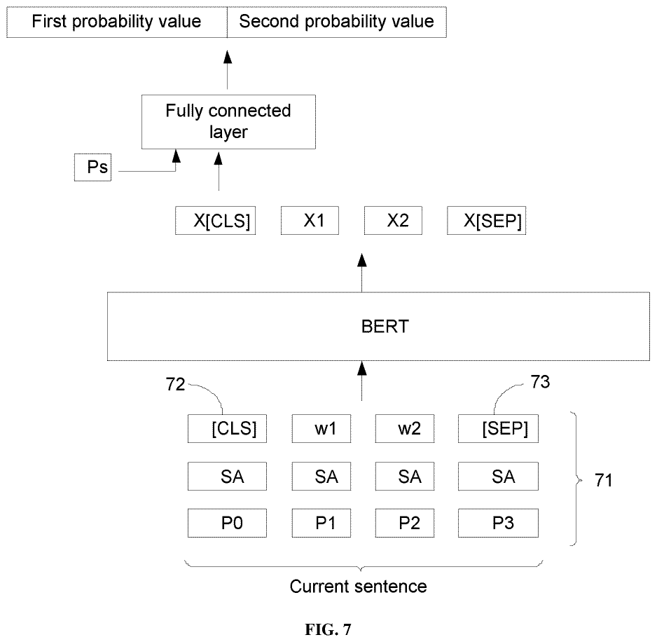

Specifically, implementations and specific principles of step S601 and step S101 are consistent, and details are not described herein again. For example, the target sentence is the current sentence as shown in FIG. 7.

In step S602, a first preset character is added to a head of the target sentence, and a second preset character is added to a tail of the target sentence, the first preset character, each text unit in the target sentence, and the second preset character being elements in a first set respectively.

For example, the current sentence includes two text units, and each text unit is a unit such as a word, a sub-word, a character, a phrase, a character string with a preset length, and the like. A first preset character, such as [CLS], is added to the head of the current sentence. A second preset character such as [SEP] is added to the tail of the current sentence. The [CLS], the two text units and the [SEP] constitute a first set, and the [CLS], the two text units and the [SEP] are elements in the first set respectively. Each element is denoted as a token.

In step S603, a word embedding vector and position information corresponding to each element in the first set and identification information of the target sentence are inputted into the trained machine learning model to output a hidden state vector representation corresponding to each element in the first set.

As shown in FIG. 7, the trained machine learning model includes a BERT and a fully connected layer. When the input of the BERT is related information of the current sentence, the machine learning model is recorded as a single-sentence-level model. Specifically, as shown in FIG. 7, a reference number 72 represents a word embedding vector corresponding to a first preset character [CLS], W1 represents a word embedding vector of a first text unit in the current sentence, W2 represents a word embedding vector of a second text unit in the current sentence. The two text units are taken as an example for schematic illustration, and in practical applications, there may be multiple text units. As shown in FIG. 7, a reference number 73 represents a word embedding vector corresponding to the second preset character [SEP]. SA is used for identifying the current sentence. P0 represents the position information of [CLS], P1 represents the position information of the first text unit in the current sentence, P2 represents the position information of the second text unit in the current sentence, and P3 represents the position information of the [SEP]. As shown in FIG. 7, three rows of data indicated by a reference number 71 are input into the BERT to output hidden state vector representations (which are referred to as hidden state representations for short) respectively corresponding to the [CLS], the two text units and the [SEP]. In some other embodiments, the hidden state vector representations can be represented in different ways. The hidden state vector representations respectively corresponding to the [CLS], the two text units, and the the [SEP] are denoted in sequence as X[CLS], X1, X2, and X[SEP]. A process from the current sentence to three rows of data indicated by the reference number 71 shown in FIG. 7 is an input encoding process as shown in FIG. 4.

In step S604, the hidden state vector representation of the first preset character is set as the representation vector of the target sentence.

In the case shown in FIG. 7, X[CLS] is set as the representation vector for the current sentence.

In step S605, a probability value containing an action item in the target sentence is determined according to the representation vector of the target sentence and position information of the target sentence in the conference record.

For example, in some embodiments, the position information of the current sentence in the conference record is obtained. For example, the conference record includes 100 sentences in total. When the current sentence is the 20th sentence in the conference record, the position information of the current sentence is represented by 0.2, and the position information of the current sentence is the PS shown in FIG. 7. Further, the PS and the X[CLS] are input to the fully connected layer to output the first probability value and the second probability value. The first probability value represents a probability that the current sentence contains the action item, and the second probability value represents a probability that the current sentence does not contain the action item. The process of the BERT processing the input three-row data, and the process of the fully-connected layer processing the PS and X[CLS] are considered as a model call process as shown in FIG. 4. The process of the fully connected layer outputting the first probability value and the second probability value is an output probability value process as shown in FIG. 4.

In step S606, in response to determining, based on the probability value, that the target sentence contains the action item, related elements of the action item are obtained, the related elements being used for assisting a user in following up on to-do items and organizing a conference summary.

Whether the current sentence contains the action item is determined according to the first probability value and the second probability value. For example, if the first probability value is greater than the second probability value, it is determined that the current sentence contains the action item.

Optionally, an operation of determining, based on the probability value, that the target sentence contains the action item includes the following steps. In response to the target sentence containing the time word representing future and the probability value is greater than a first threshold, determining that the target sentence contains the action item; and in response to the target sentence containing the time word representing present or pending, and the probability value is greater than a second threshold, determining that the target sentence contains the action item, the first threshold being less than the second threshold.

As shown in FIG. 4, after the action item model outputs the probability value, in some embodiments, the post-processing is further performed on the first probability value or the second probability value. For example, a multi-level threshold can be set. If the current sentence includes a time word representing future, that is, the current sentence contains an explicit time word representing future, it indicates that there is a high probability to contain an action item in the current sentence. In this case, a lower threshold is selected, and the lower threshold is denoted as the first threshold. That is, in this case, if the first probability value corresponding to the current sentence is greater than the first threshold, it is determined that the current sentence contains the action item.

In addition, if the current sentence contains the time word representing present or pending, or the current sentence contains a present time word or a pending time word, a more strict constraint is required. In this case, a higher threshold is selected, and the higher threshold is denoted as the second threshold. That is, in this case, if the first probability value corresponding to the current sentence is greater than the second threshold, it is determined that the current sentence contains the action item.

In addition, as shown in FIG. 4, in some embodiments, a whitelist link and a rejection logic is further set. The white list link and the machine learning model are parallel. That is, even if the first probability value corresponding to the current sentence is not greater than the corresponding threshold, the current sentence is determined to contain the action item as long as the current sentence conforms to rules of the white list link. In some embodiments, the rules in the whitelist link are all high-confidence action item recall rules. Similarly, some rules for rejecting logic are further set. For example, if the first probability value corresponding to the current sentence is greater than the corresponding threshold, it is considered that the current sentence does not contain the action item even if the first probability value corresponding to the current sentence is greater than the corresponding threshold, so that the current sentence is filtered out. That is, the current sentence cannot be output as the sentence containing the action item. Therefore, some obvious false recall results can be filtered out in some embodiments, and the system controllability can be enhanced.

In addition, when it is determined that the current sentence contains the action item, related elements of the action item may also be obtained. Optionally, the related elements of the action item include: time information of the action item, the time information includes: a time word in the target sentence and a timestamp corresponding to the time word.

For example, a time point is very important information for the to-do item. Therefore, in some embodiments, through parsing the rule, the time word in the current sentence is parsed into a corresponding timestamp, that is, the parsing of the timestamp shown in FIG. 7. For example, the time word in the current sentence is “tomorrow” and it is assumed that the conference time is May 24, “tomorrow” corresponds to May 25, and May 25 is set as the timestamp corresponding to the “tomorrow”.

Optionally, the method further includes the following steps. In response to timestamps corresponding to all the time words in the target sentence being earlier than a reference time point, determining that the target sentence does not contain the action item, the reference time point being related to at least one conference time point.

For example, if the timestamps corresponding to all the time words in the current sentence are earlier than the reference time point, the reference time point is related to the at least one conference time point. For example, the reference time point is a conference start time point, a conference intermediate time point, or a conference end time point, it indicates that the current sentence does not contain the action item, and in this case, the current sentence is discarded. That is, the current sentence cannot be output as the sentence containing the action item. The conference time point is generally the conference end time. Assuming that the current sentence is not discarded after parsing the timestamp, it indicates that the current sentence meets the requirement of the post-processing rule and the requirement of timestamp parsing. In this case, it indicates that the current sentence can be output. Specifically, the time word in the current sentence and the timestamp corresponding to the time word can be returned as time information, that is, the returning of time information shown in FIG. 7.

In addition, in response to determining that the current sentence contains the action item, characters, words or phrases with a small information amount in the current sentence are further removed, for example, spoken words such as “Hmm”, “Ah”, “this” and the like. In addition, a written method is called to alleviate the problems of redundancy, repetition, fragmentation and the like in spoken language, and a relatively spoken current sentence is converted into a sentence closer to written, that is, the formal description shown in FIG. 7. Finally, an action item statement and the corresponding time information are returned. The action item statement refers to a sentence or statement containing the action item. The action item statement and the corresponding time information are added to the to-do item of the conference summary, thereby gradually perfecting the conference summary. In addition, a mail is sent to remind a person in charge of the action item.

In some embodiments, the sentence containing the action item can be automatically recognized through the machine learning model, the user is assisted to follow up on to-do items and organize the conference summary, so that the generation efficiency of the conference summary and the post-conference work efficiency are improved. In an off-line test set, a F1 performance index of the machine learning model is ideal. Although some conferencing software in the related art may provide a template of the conference summary, the user needs to fill in the conference summary. However, in some embodiments of the present disclosure, the sentence containing the action item can be automatically recognized by using the machine learning model, that is, the machine learning model may automatically recognize, from the conference record, the content which is required to be sorted into the conference summary. In addition, some other software in the related art allows the user to mark or record important text information in a conference process, for example, providing important text information to the user in a highlight manner, but an organization process of the conference summary is also completed by the user, and the smoothness of the conference is also damaged. However, in some embodiments, the user does not need to check or mark important text information in the conference process, so that the destructive effect can be well avoided.

On the basis of the foregoing embodiments, an operation of at least encoding the target sentence by using the trained machine learning model to obtain the representation vector of the target sentence includes the following step. A previous sentence of the target sentence, the target sentence, and a next sentence of the target sentence are encoded by using the trained machine learning model to obtain the representation vector of the target sentence.

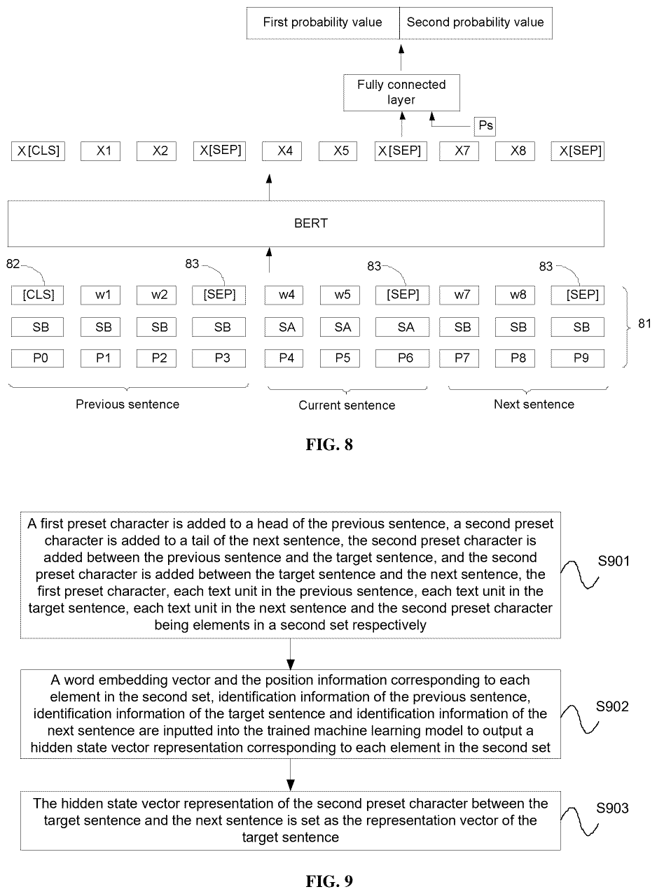

For example, as shown in FIG. 8, the input of the BERT includes not only the related information of the current sentence, but also the related information of the previous sentence and the next sentence of the current sentence. Therefore, the BERT encodes the previous sentence, the current sentence, and the next sentence together to obtain the representation vector of the current sentence.

Specifically, the process of encoding the previous sentence of the target sentence, the target sentence, and the next sentence of the target sentence by using the trained machine learning model to obtain the representation vector of the target sentence, including the following steps shown in FIG. 9.

In step S901, a first preset character is added to a head of the previous sentence, a second preset character is added to a tail of the next sentence, the second preset character is added between the previous sentence and the target sentence, and the second preset character is added between the target sentence and the next sentence, the first preset character, each text unit in the previous sentence, each text unit in the target sentence, each text unit in the next sentence and the second preset character being elements in a second set respectively.

For example, as shown in FIG. 8, the first preset character such as the [CLS] is added to the head of the previous sentence, the second preset character such as the [SEP] is added to the tail of the next sentence, the second preset character such as the [SEP] is added between the previous sentence and the current sentence, and the second preset character such as the [SEP] is added between the current sentence and the next sentence. It is assumed that the previous sentence, the current sentence, and the next sentence respectively include two text units. The [CLS], two text units in the previous sentence (Here, two text units are used for illustrative purposes, in actual applications, there may be many text units involved), the [SEP] between the previous sentence and the current sentence, two text units in the current sentence, the [SEP] between the current sentence and the next sentence, two text units in the next sentence, and the [SEP] at the tail of the next sentence constitute the second set, and each [CLS], each [SEP], and each text unit are elements in the second set, respectively.

In step S902, a word embedding vector and the position information corresponding to each element in the second set, identification information of the previous sentence, identification information of the target sentence and identification information of the next sentence are inputted into the trained machine learning model to output a hidden state vector representation corresponding to each element in the second set.

As shown in FIG. 8, the trained machine learning model includes a BERT and a fully connected layer. When the input of the BERT includes the previous sentence, the current sentence, and the related information corresponding to the next sentence, the machine learning model is denoted as a context level model. Specifically, a reference number 82 represents a word embedding vector corresponding to the [CLS], W1 represents a word embedding vector of a first text unit in the previous sentence, W2 represents a word embedding vector of a second text unit in the previous sentence, and a reference number 83 represents a word embedding vector corresponding to the [SEP]. W4 represents the word embedding vector of the first text unit in the current sentence, W5 represents the word embedding vector of the second text unit in the current sentence, W7 represents the word embedding vector of the first text unit in the next sentence, and W8 represents the word embedding vector of the second text unit in the next sentence. SA is used for identifying the current sentence. SB is used for identifying the previous sentence and the next sentence. PO represents the position information of the [CLS], P1 represents the position information of the first text unit in the previous sentence, P2 represents the position information of the second text unit in the previous sentence, P3 represents the position information of the [SEP] between the previous sentence and the current sentence, P4 represents the position information of the first text unit in the current sentence, P5 represents the position information of the second text unit in the current sentence, P6 represents the position information of the [SEP] between the current sentence and the next sentence, P7 represents the position information of the first text unit in the next sentence, P8 represents the position information of the second text unit in the next sentence, and P9 represents the position information of the [SEP] at the tail of the next sentence. As shown in FIG. 8, the three rows of data shown in a reference number 81 are input into the BERT to output the hidden state vector representation corresponding to each element in the second set. The hidden state vector representations respectively corresponding to each element in the second set are denoted as X [CLS], X1, X2, X[SEP], X4, X5, X[SEP], X7, X8, X[SEP].

In step S903, the hidden state vector representation of the second preset character between the target sentence and the next sentence is set as the representation vector of the target sentence.

For example, in the case shown in FIG. 8, some embodiments set the hidden state vector representation of the [SEP] between the current sentence and the next sentence as the representation vector x[SEP] of the current sentence. Furthermore, the position information PS of the current sentence in the conference record is determined, and the PS and X[SEP] are input to the fully connected layer to output the first probability value and the second probability value. In some embodiments, the previous sentence and the next sentence are recorded as the context of the current sentence.

In some embodiments, the previous sentence of the current sentence, the current sentence, and the related information of the next sentence of the current sentence are input into the machine learning model, so that the machine learning model refers to the related information of the context in the process of calculating the representation vector of the current sentence, thereby improving the calculation precision of the representation vector of the current sentence.

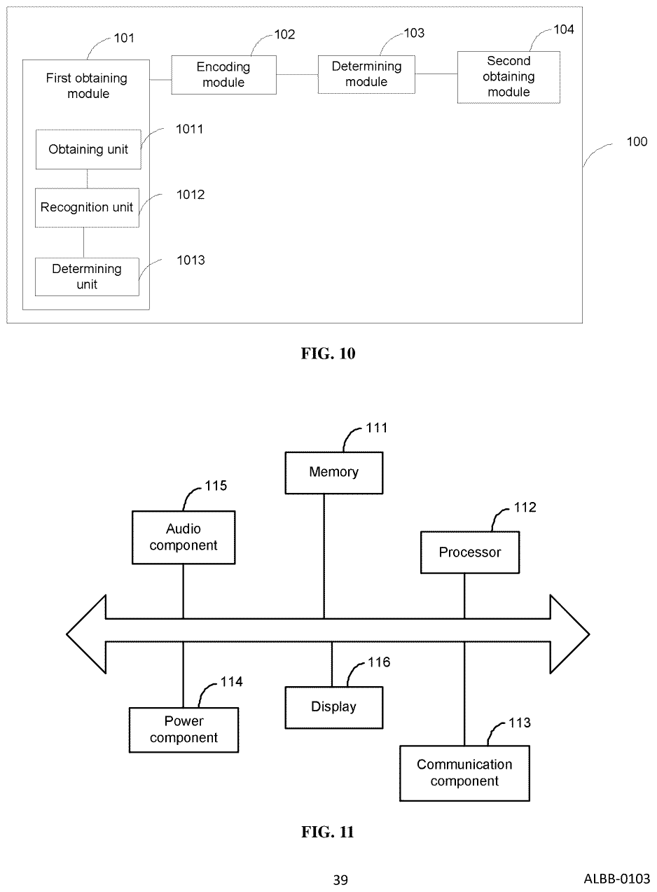

FIG. 10 is a structural schematic diagram of a conference record processing apparatus according to some embodiments of the present disclosure. The conference record processing apparatus provided in some embodiments of the present disclosure performs the processing flows provided in the embodiments of the conference record processing method, as shown in FIG. 10, the conference record processing apparatus 100 includes:
a first obtaining module 101, arranged for obtaining a target sentence to be processed in a conference record;
an encoding module 102, arranged for at least encoding the target sentence by using a trained machine learning model to obtain a representation vector of the target sentence;
a determining module 103, arranged for determining a probability value containing an action item in the target sentence according to the representation vector of the target sentence; and
a second obtaining module 104, arranged for in response to determining, based on the probability value, that the target sentence contains the action item, obtaining related elements of the action item, the related elements being used for assisting a user in following up on to-do items and organizing a conference summary.

Optionally, when the encoding module 102 is arranged for at least encoding the target sentence by using the trained machine learning model to obtain the representation vector of the target sentence, the encoding module 102 is specifically arranged for:
adding a first preset character to a head of the target sentence, and adding a second preset character to a tail of the target sentence, the first preset character, each text unit in the target sentence, and the second preset character being elements in a first set respectively;
inputting a word embedding vector and position information corresponding to each element in the first set and identification information of the target sentence into the trained machine learning model to output a hidden state vector representation corresponding to each element in the first set; and
setting the hidden state vector representation of the first preset character as the representation vector of the target sentence.

Optionally, when the encoding module 102 is arranged for at least encoding the target sentence by using the trained machine learning model to obtain the representation vector of the target sentence, the encoding module 102 is specifically arranged for:
encoding a previous sentence of the target sentence, the target sentence, and a next sentence of the target sentence by using the trained machine learning model to obtain the representation vector of the target sentence.

Optionally, when the encoding module 102 is arranged for encoding the previous sentence of the target sentence, the target sentence, and the next sentence of the target sentence by using the trained machine learning model to obtain the representation vector of the target sentence, the encoding module 102 is specifically arranged for:
adding a first preset character to a head of the previous sentence, adding a second preset character to a tail of the next sentence, adding the second preset character between the previous sentence and the target sentence, and adding the second preset character between the target sentence and the next sentence, the first preset character, each text unit in the previous sentence, each text unit in the target sentence, each text unit in the next sentence and the second preset character being elements in a second set respectively;
inputting a word embedding vector and the position information corresponding to each element in the second set, identification information of the previous sentence, identification information of the target sentence and identification information of the next sentence into the trained machine learning model to output a hidden state vector representation corresponding to each element in the second set; and
setting the hidden state vector representation of the second preset character between the target sentence and the next sentence as the representation vector of the target sentence.

Optionally, the first obtaining module 101 includes an obtaining unit 1011, a recognition unit 1012, and a determining unit 1013. The obtaining unit 1011 is arranged for obtaining any sentence in the conference record. The recognition unit 1012 is arranged for recognizing at least one of a time word and an action word in the any sentence. The determining unit 1013 is arranged for, in response to at least one of the time word and the action word being contained in the any sentence at the same time, determining that the any sentence is the target sentence to be processed.

Optionally, when recognizing at least one of the time word and the action word in the any sentence, the recognition unit 1012 is specifically arranged for:
in response to the any sentence not containing any sensitive word and/or a length of the any sentence meeting a preset condition, recognizing at least one of the time word and the action word in the any sentence.

Optionally, when the determining module 103 is arranged for determining, based on the probability value, that the target sentence contains the action item, the determining module 103 is specifically arranged for:
in response to the target sentence containing the time word representing future and the probability value is greater than a first threshold, determining that the target sentence contains the action item; and
in response to the target sentence containing the time word representing present or pending, and the probability value is greater than a second threshold, determining that the target sentence contains the action item, the first threshold being less than the second threshold.

Optionally, the related elements of the action item include: time information of the action item, the time information includes: a time word in the target sentence and a timestamp corresponding to the time word.

Optionally, the determining module 103 is further arranged for, in response to timestamps corresponding to all the time words in the target sentence being earlier than a reference time point, determining that the target sentence does not contain the action item, the reference time point being related to at least one conference time point.

The conference record processing apparatus in the embodiment shown in FIG. 10 is arranged for performing the technical solutions of the foregoing method embodiments, and implementation principles and technical effects thereof are similar, and details are not described herein again.

The internal functions and structures of the conference record processing apparatus are described above, and the apparatus can be implemented as an electronic device. FIG. 11 is a structural schematic diagram of an electronic device according to some embodiments of the present disclosure. As shown in FIG. 11, the electronic device includes a memory 111 and a processor 112.

The memory 111 is arranged for storing a program. In addition to the program described above, the memory 111 is further arranged for storing various other data to support operations on the electronic device. Examples of such data include instructions, contact data, phonebook data, messages, pictures, videos, etc. for any application or method operating on the electronic device.

The memory 111 is implemented by any type of volatile or non-transitory storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The processor 112 is coupled with the memory 111 to execute the program stored in the memory 111, and the program includes:
obtaining a target sentence to be processed in a conference record;
at least encoding the target sentence by using a trained machine learning model to obtain a representation vector of the target sentence;
determining a probability value containing an action item in the target sentence according to the representation vector of the target sentence; and
in response to determining, based on the probability value, that the target sentence contains the action item, obtaining related elements of the action item, the related elements being used for assisting a user in following up on to-do items and organizing a conference summary.

Further, as shown in FIG. 11, the electronic device further includes other components, such as a communication component 113, a power component 114, an audio component 115, and a display 116. Some components are schematically shown in FIG. 11, but it does not mean that the electronic device includes only the components shown in FIG. 11.

The communication component 113 is arranged for facilitating wired or wireless communication between the electronic device and other devices. The electronic device may access a wireless network based on a communication standard, such as Wi-Fi, 2G, 3G, or a combination thereof. In some exemplary embodiments, the communication component 113 receives a broadcast signal or broadcast related information from an external broadcast management system via a broadcast channel. In some exemplary embodiments, the communication component 113 further includes a near field communication (NFC) module to facilitate short-range communication. For example, the NFC module is implemented based on a radio frequency identification (RFID) technology, an infrared data association technology, an ultra-wideband (UWB) technology, a Bluetooth (BT) technology, and other technologies.

The power component 114 provides power for various components of the electronic device. The power component 114 includes a power management system, at least one power source, and other components associated with generating, managing, and distributing power for the electronic device.

The audio component 115 is arranged for outputting and/or inputting audio signals. For example, the audio component 115 includes a microphone (MIC) arranged for receiving an external audio signal when the electronic device is in an operation mode, such as a call mode, a recording mode, and a voice recognition mode. The received audio signal is further stored in the memory 111 or transmitted via the communication component 113. In some embodiments, the audio component 115 further includes a speaker to output audio signals.

The display 116 includes a screen, which includes a liquid crystal display (LCD) and a touch panel (TP). In response to the screen including the touch panel, the screen is implemented as a touch screen to receive input signals from the user. The touch panel includes at least one touch sensor to sense touches, swipes, and gestures on the touch panel. The at least one touch sensor not only senses a boundary of a touch or swipe action, but also detects a duration and pressure associated with the touch or swipe action.

In addition, some embodiments of the present disclosure further provide a computer-readable storage medium storing a computer program. The computer program is executed by a processor to implement the conference record processing method described in the foregoing embodiments.

It should be noted that, in this specification, relational terms such as “first” and “second” are used for distinguishing one entity or operation from another entity or operation, and do not necessarily require or imply that any such actual relationship or sequence exists between these entities or operations. Moreover, the terms “comprising”, “including” or any other variation thereof are intended to cover a non-exclusive inclusion, so that a process, method, article, or device that includes a series of elements includes not only those elements, but also other elements that are not explicitly listed, or elements inherent to such a process, method, article, or device. In the absence of further restrictions, the element specified by the phrase “including one . . . ” does not preclude the existence of additional identical elements within the process, method, item, or device which includes the aforementioned element.

The above are specific implementations of the present disclosure, so that those skilled person in the art can understand or implement the present disclosure. Various modifications to these embodiments will be readily apparent to those skilled person in the art, and the generic principles defined herein are implemented in other embodiments without departing from the spirit or scope of the disclosure. Thus, the present disclosure shall not be limited to the embodiments described above, but shall be construed to cover the broadest scope consistent with the principles and novel features disclosed herein.

1. A conference record processing method, wherein the method comprises:
obtaining a target sentence to be processed in a conference record;
at least encoding the target sentence by using a trained machine learning model to obtain a representation vector of the target sentence;
determining a probability value containing an action item in the target sentence according to the representation vector of the target sentence; and
in response to determining, based on the probability value, that the target sentence contains the action item, obtaining related elements of the action item, the related elements being used for assisting a user in following up on to-do items and organizing a conference summary.

2. The method as claimed in claim 1, wherein at least encoding the target sentence by using the trained machine learning model to obtain the representation vector of the target sentence comprises:
adding a first preset character to a head of the target sentence, and adding a second preset character to a tail of the target sentence, the first preset character, each text unit in the target sentence, and the second preset character being elements in a first set respectively;
inputting a word embedding vector and position information corresponding to each element in the first set and identification information of the target sentence into the trained machine learning model to output a hidden state vector representation corresponding to each element in the first set; and
setting the hidden state vector representation of the first preset character as the representation vector of the target sentence.

3. The method as claimed in claim 1, wherein at least encoding the target sentence by using the trained machine learning model to obtain the representation vector of the target sentence comprises:
encoding a previous sentence of the target sentence, the target sentence, and a next sentence of the target sentence by using the trained machine learning model to obtain the representation vector of the target sentence.

4. The method as claimed in claim 3, wherein encoding the previous sentence of the target sentence, the target sentence, and the next sentence of the target sentence by using the trained machine learning model to obtain the representation vector of the target sentence comprises:
adding a first preset character to a head of the previous sentence, adding a second preset character to a tail of the next sentence, adding the second preset character between the previous sentence and the target sentence, and adding the second preset character between the target sentence and the next sentence, the first preset character, each text unit in the previous sentence, each text unit in the target sentence, each text unit in the next sentence and the second preset character being elements in a second set respectively;
inputting a word embedding vector and the position information corresponding to each element in the second set, identification information of the previous sentence, identification information of the target sentence and identification information of the next sentence into the trained machine learning model to output a hidden state vector representation corresponding to each element in the second set; and
setting the hidden state vector representation of the second preset character between the target sentence and the next sentence as the representation vector of the target sentence.

5. The method as claimed in claim 1, wherein obtaining the target sentence to be processed in the conference record comprises:
obtaining any sentence in the conference record;
recognizing at least one of a time word and an action word in the any sentence; and
in response to at least one of the time word and the action word being contained in the any sentence at the same time, determining that the any sentence is the target sentence to be processed.

6. The method as claimed in claim 5, wherein recognizing at least one of the time word and the action word in the any sentence comprises:
in response to the any sentence not containing any sensitive word and/or a length of the any sentence meeting a preset condition, recognizing at least one of the time word and the action word in the any sentence.

7. The method as claimed in claim 1, wherein determining, based on the probability value, that the target sentence contains the action item comprises:
in response to the target sentence containing the time word representing future and the probability value is greater than a first threshold, determining that the target sentence contains the action item; and
in response to the target sentence containing the time word representing present or pending, and the probability value is greater than a second threshold, determining that the target sentence contains the action item, the first threshold being less than the second threshold.

8. The method as claimed in claim 1, wherein the related elements of the action item comprise: time information of the action item, the time information comprises: a time word in the target sentence and a timestamp corresponding to the time word.

9. The method as claimed in claim 8, wherein the method further comprises:
in response to timestamps corresponding to all the time words in the target sentence being earlier than a reference time point, determining that the target sentence does not contain the action item, the reference time point being related to at least one conference time point.

10. (canceled)

11. An electronic device, comprising:
a memory;
a processor; and
a computer program;
wherein the computer program is stored in the memory and arranged for being executed by the processor to implement the following steps:
obtaining a target sentence to be processed in a conference record;
at least encoding the target sentence by using a trained machine learning model to obtain a representation vector of the target sentence;
determining a probability value containing an action item in the target sentence according to the representation vector of the target sentence; and
in response to determining, based on the probability value, that the target sentence contains the action item, obtaining related elements of the action item, the related elements being used for assisting a user in following up on to-do items and organizing a conference summary.

12. A computer-readable storage medium storing a computer program, wherein the computer program, when being executed by a processor, implements the following steps:
obtaining a target sentence to be processed in a conference record;
at least encoding the target sentence by using a trained machine learning model to obtain a representation vector of the target sentence;
determining a probability value containing an action item in the target sentence according to the representation vector of the target sentence; and
in response to determining, based on the probability value, that the target sentence contains the action item, obtaining related elements of the action item, the related elements being used for assisting a user in following up on to-do items and organizing a conference summary.

13. The method as claimed in claim 1, wherein the conference summary comprises: the related elements of the action item, a conference issue, a conference conclusion, and a question discussed in the conference.

14. The method as claimed in claim 1, wherein the action item refers to a specific action item performed by a conference-related party after a conference.

15. The method as claimed in claim 1, wherein determining the probability value containing the action item in the target sentence according to the representation vector of the target sentence comprises:
determining the probability value containing the action item in the target sentence according to the representation vector of the target sentence and position information of the target sentence in the conference record.

16. The method as claimed in claim 1, wherein the trained machine learning model is obtained through three training stages containing a first training stage, a second training stage and a third training stage.

17. The method as claimed in claim 16, wherein sample data used in the first training stage is a Chinese written text.

18. The method as claimed in claim 16, wherein sample data used in the second training stage is the conference record or a conference text.

19. The method as claimed in claim 16, wherein sample data used in the third training stage is annotation data containing a sentence containing the action item and a sentence that does not contain the action item, the sentence containing the action item being marked as a positive example, and the sentence that does not contain the action item being marked as a negative example.

20. The method as claimed in claim 5, wherein the method further comprises:
in response to the any sentence containing both the time word and the action word, determining that the any sentence is the target sentence to be processed.
